(19) United States
(12) Patent Application Publication
(10) Pub. No.: US 2022/0212981 A1
(43) Pub. Date: Jul. 7, 2022

(54) GLASS SHEETS WITH COPPER FILMS AND METHODS OF MAKING THE SAME

(71) Applicant: Corning Incorporated, Corning, NY (US)

(72) Inventors: Ming-Huang Huang, Ithaca, NY (US); Hoon Kim, Horseheads, NY (US); Robert George Manley, Vestal, NY (US); Rajesh Vaddi, Horseheads, NY (US); Nikolay Zhelev Zhelev, Painted Post, NY (US); Bin Zhu, Ithaca, NY (US)

(21) Appl. No.: 17/609,110

(22) PCT Filed: May 13, 2020
(86) PCT No.: PCT/US2020/032553

§ 371 Date: Nov. 5, 2021

Related U.S. Application Data
(60) Provisional application No. 62/849,319, filed on May 17, 2019.

(51) Int. Cl. C03C 17/09; C03C 17/00; C03C 3/091

(52) U.S. Cl. CPC C03C 17/09; C03C 17/002; C03C 3/091; C03C 2218/31; C03C 2217/70; C03C 2218/154; C03C 2217/253

(57) ABSTRACT

A method of depositing a copper film on a major surface of a glass sheet includes determining a desired range of a property of the copper film, correlating a thermal history of the glass sheet to the desired range of the property of the copper film, and depositing the copper film on the major surface of the glass sheet, wherein the property of the copper film deposited on the glass sheet is within the desired range. Correlating the thermal history of the glass sheet to the desired range of the property of the copper film can include heat treating glass sheet prior to depositing the copper film on the glass sheet.

This application claims the benefit of priority under 35 U.S.C. § 119 of U.S. Provisional Application Ser. No. 62/849,319, filed on May 17, 2019, the content of which is relied upon and incorporated herein by reference in its entirety.

### FIELD

The present disclosure relates generally to glass sheets with copper films and more particularly to depositing copper films on glass sheets using the thermal history of the glass sheets to control one or more properties of the copper films to be within a desired range.

### BACKGROUND

Copper is drawing a considerable amount of attention as an alternative metallization material for ultra large-scale integration (ULSI) applications because of its low electrical resistivity and good electro migration resistance. More recently, copper has attracted substantial interest for flat panel display applications, which require lower electrical resistivity and narrower metal line for higher resolution display and/or larger size displays.

Sputter deposition technologies are widely used for copper metallization processes. Generally, the structure and qualities of copper films strongly depend on parameters of the deposition process. Such process parameters include, for example, sputtering gas composition and pressure, type of plasma power source, deposition power, and sheet temperature. Properties of the copper films that can be affected by deposition parameters include conductivity, film stress, crystallization, crystal orientation, and surface roughness. The desired range of such properties can vary depending on the ultimate application.

Varying deposition process parameters to control properties of the copper films (e.g., for different applications) involves complexity, time, and expense. Accordingly, it would be desirable to control properties of the copper films without needing to vary such process parameters.

### SUMMARY

Embodiments disclosed herein include a method of depositing a copper film on a major surface of a glass sheet. The method includes determining a desired range of a property of the copper film. The method also includes correlating a thermal history of the glass sheet to the desired range of the property of the copper film. In addition, the method includes depositing the copper film on the major surface of the glass sheet, wherein the property of the copper film deposited on the glass sheet is within the desired range.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is a perspective view of a glass sheet;

FIG. 3 is a schematic view of a copper deposition process on a first major surface of a glass sheet;

FIG. 4 is a side view of a glass sheet with a copper film deposited on a major surface thereon;

FIG. 5 is a chart showing surface roughness of glass sheets subjected to heat treatment and a control glass sheet not subjected to heat treatment;

FIG. 6 is a chart showing calculated copper film stress on glass sheets subjected to heat treatment and a control glass sheet not subjected to heat treatment;

FIG. 7 is a chart showing measured copper film surface roughness on glass sheets subjected to heat treatment and a control glass sheet not subjected to heat treatment;

FIG. 8 is an X-ray diffraction curve of copper film deposited on a control glass sheet; and

FIG. 9 is a chart showing calculated copper film average crystallite size on glass sheets subjected to heat treatment and a control glass sheet not subjected to heat treatment.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

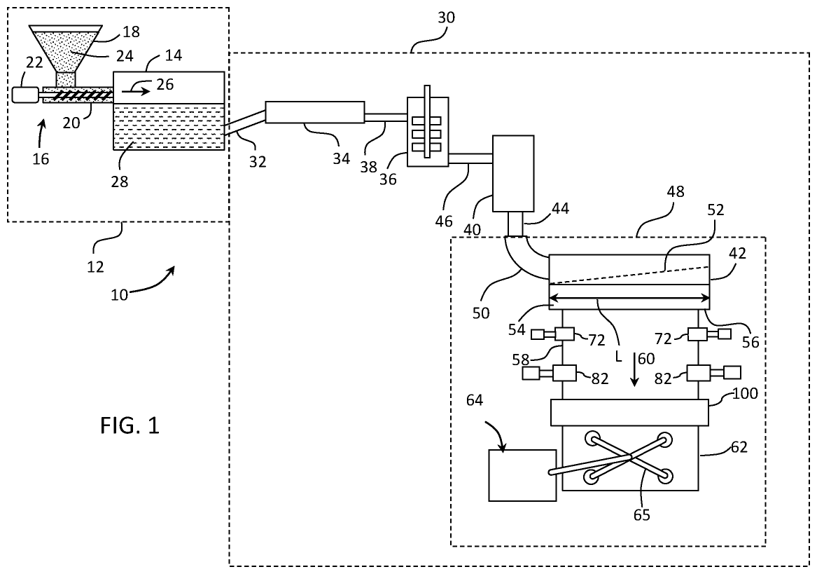

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass sheet, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process, or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

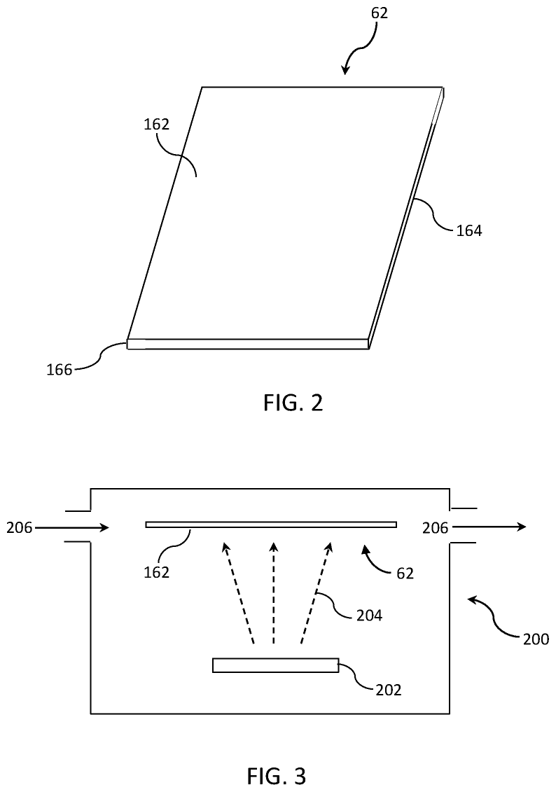

FIG. 2 shows a perspective view of a glass sheet 62 having a first major surface 162, a second major surface 164 extending in a generally parallel direction to the first major surface 162 (on the opposite side of the glass sheet 62 as the first major surface) and an edge surface 166 extending between the first major surface 162 and the second major surface 164 and extending in a generally perpendicular direction to the first and second major surfaces 162, 164.

FIG. 3 shows a schematic view of a copper deposition process on a first major surface 162 of a glass sheet 62. As shown in FIG. 3, deposition process incudes ejecting sputtered copper atoms 204 onto first major surface 162 from a target 202 inside a chamber 200 through which a sputtering gas (e.g., an inert gas) 206 is flowed. Such copper deposition processes can include sputtering processes as known to persons of ordinary skill in the art.

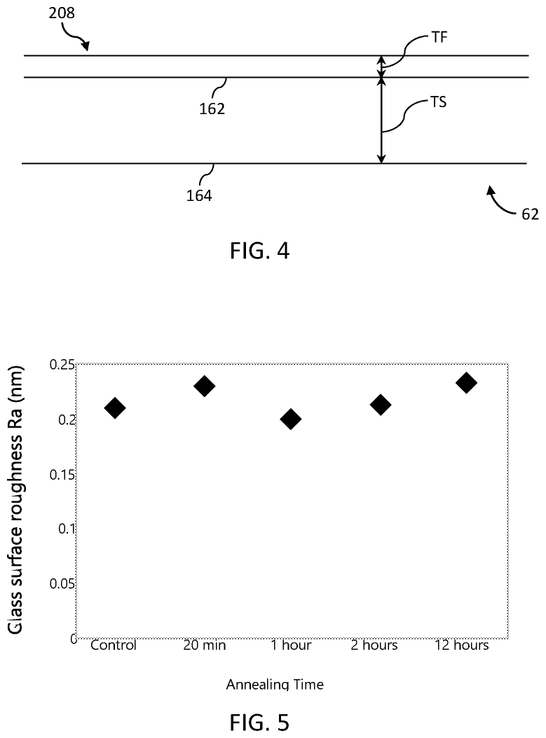

FIG. 4 shows a side view of a glass sheet 62 with a copper film 208 deposited on a first major surface 162 of the glass sheet 62. While not limited, thickness of glass sheet 62 (i.e., distance between first major surface 162 and second major surface 164 as indicated by arrow TS) can, for example, range from about 0.1 millimeter to about 0.5 millimeters, such as from about 0.2 millimeters to about 0.4 millimeters. While not limited, thickness of copper film 208 (as indicated by arrow TF) can, for example, range from about 50 nanometers to about 1000 nanometers, such as from about 100 nanometers to about 500 nanometers.

Copper film 208 can have a variety of properties including, but not limited to, surface roughness, film stress, and average crystallite size. Such properties can be controlled to be within a desired range by, for example, adjusting the parameters of the copper deposition process.

Embodiments disclosed herein include determining a desired range of a property of a copper film 208, correlating a thermal history of the glass sheet 62 to the desired range of the property of the copper film 208, and depositing the copper film 208 on a major surface of the glass sheet 62, wherein the property of the copper film 208 deposited on the glass sheet 62 is within the desired range. Such embodiments can enable tuning the copper film 208 to exhibit the property within the desired range without necessarily changing the copper deposition process parameters. Alternatively stated, embodiments disclosed herein can enable using the same or similar copper deposition process to generate copper films deposited on glass sheets, wherein the copper films can have different properties depending on the thermal history of the glass sheets.

Correlating a thermal history of the glass sheet 62 to the desired range of the property of the copper film 208 includes predicting a property of the copper film 208 as a result of that thermal history. Correlating a thermal history of the glass sheet 62 to the desired range of the property of the copper film 208 can also include adjusting that thermal history. For example, adjusting the thermal history of the glass sheet can include heat treating the glass sheet 62 for a predetermined time and temperature prior to depositing the copper film on a major surface of the glass sheet 62.

Heat treating the glass sheet 62 for a predetermined time and temperature can include increasing the temperature of the glass sheet 62 from, for example, a temperature ranging from about 20° C. to about 30° C. to a maximum heat treatment temperature and then holding the temperature of the glass sheet 62 for a heat treatment time at the maximum heat treatment temperature. Such heat treatment time can, for example, range from about 20 minutes to about 12 hours, such as from about 20 minutes to about 2 hours, and further such as from about 20 minutes to about 1 hour and the maximum heat treatment temperature can for example, range from about 350° C. to about 700° C., such as from about 500° C. to about 600° C.

In certain exemplary embodiments, heat treating the glass sheet 62 can occur in a controlled environment, such as an environment wherein a gaseous fluid surrounding the glass sheet 62 is compositionally controlled within a predetermined range. For example, embodiments disclosed herein include those in which an environment surrounding the glass sheet 62 is mainly comprised of a gas selected from nitrogen, helium and/or argon. Such exemplary embodiments include those in which the heat treating the glass sheet 62 comprises enclosing the glass sheet 62 in a chamber through which a stream of nitrogen is flowed, such that the glass sheet 62 is surrounded by a gaseous fluid comprising at least about 90 mol %, such as at least 95 mol %, and further such as at least 99 mol %, including from about 90 mol % to about 99.99 mol %, such as from about 95 mol % to about 99.9 mol % nitrogen.

Following heat treatment at the maximum heat treatment temperature and time, the temperature of the glass sheet 62 can be lowered back to a temperature ranging from, for example, about 20° C. to about 30° C. The raising and lowering of the temperature of the glass sheet 62, while not limited to any particular rate, can, for example, range from about 1° C./minute to about 300° C./minute, such as from about 10° C./minute to about 100° C./minute.

Embodiments disclosed herein include those in which correlating a thermal history of the glass sheet 62 to the desired range of the property of the copper film 208 comprises correlating the thermal history to the surface roughness, film stress, or average crystallite size of the copper film 208. In certain exemplary embodiments, correlating the thermal history to the surface roughness, film stress, or average crystallite size of the copper film 208 comprises heat treating the glass sheet for a predetermined time prior to depositing the copper film on a major surface of the glass sheet 62.

In certain exemplary embodiments, the property is film stress and the heat treatment time ranges from about 20 minutes to about 2 hours and the maximum heat treatment temperature ranges from about 350° C. to about 700° C., such as from about 500° C. to about 600° C. In certain exemplary embodiments, wherein the property is surface roughness and the heat treatment time ranges from about 20 minutes to about 12 hours and the maximum heat treatment temperature ranges from about 350° C. to about 700° C., such as from about 500° C. to about 600° C. In certain exemplary embodiments, the property is average crystallite size and the heat treatment time ranges from about 20 minutes to about 12 hours and the maximum heat treatment temperature ranges from about 350° C. to about 700° C., such as from about 500° C. to about 600° C.

Embodiments disclosed herein may be used with a variety of glass compositions. Such compositions may, for example, include a glass composition, such as an alkali free glass composition, comprising 58-65 weight percent (wt %) SiO₂, 14-20 wt % Al₂O₃, 8-12 wt % B₂O₃, 1-3 wt % MgO, 5-10 wt % CaO, and 0.5-2 wt % SrO. Such compositions may also include a glass composition, such as an alkali free glass composition, comprising 58-65 wt % SiO₂, 16-22 wt % Al₂O₃, 1-5 wt % B₂O₃, 1-4 wt % MgO, 2-6 wt % CaO, 1-4 wt % SrO, and 5-10 wt % BaO. Such compositions may further include a glass composition, such as an alkali free glass composition, comprising 57-61 wt % SiO₂, 17-21 wt % Al₂O₃, 5-8 wt % B₂O₃, 1-5 wt % MgO, 3-9 wt % CaO, 0-6 wt % SrO, and 0-7 wt % BaO. Such compositions may additionally include a glass composition, such as an alkali containing glass composition, comprising 55-72 wt % SiO₂, 12-24 wt % Al₂O₃, 10-18 wt % Na₂O, 0-10 wt % B₂O₃, 0-5 wt % K₂O, 0-5 wt % MgO, and 0-5 wt % CaO, which, in certain embodiments, may also include 1-5 wt % K₂O and 1-5 wt % MgO.

### EXAMPLES

Embodiments disclosed herein are further illustrated by the following non-limiting examples.

Corning® EagleXG® glass wafers having a diameter of about 6 inches and a thickness of about 0.5 millimeters were heat treated by raising the temperature of the glass wafers from about 25° C. to about 600° C. in an enclosure through which nitrogen gas was constantly flowed and then held at about 600° C. in the enclosure for various times ranging from about 20 minutes to about 12 hours. Glass wafers held at times ranging from about 20 minutes to about one hour were heated from about 25° C. to about 600° C. at a rate of about 20° C./minute. Glass wafers held at times ranging from about 2 hours to about 12 hours were heated from about 25° C. to about 600° C. at a rate of about 5° C./minute.

The surface roughness of the glass wafers subjected to the heat treatment and a control glass sheet not subjected to the heat treatment was measured using atomic force microscopy (AFM) with the results shown in FIG. 5. As can be seen from FIG. 5, no significant change in glass sheet surface roughness was observed as a function of heat treatment time.

A copper film having a thickness of about 700 nanometers was directly deposited on a major surface of the glass wafers using a sputter deposition technique. The same copper deposition technique was used for the control glass sheet as well as the glass wafers that were heat treated for various times.

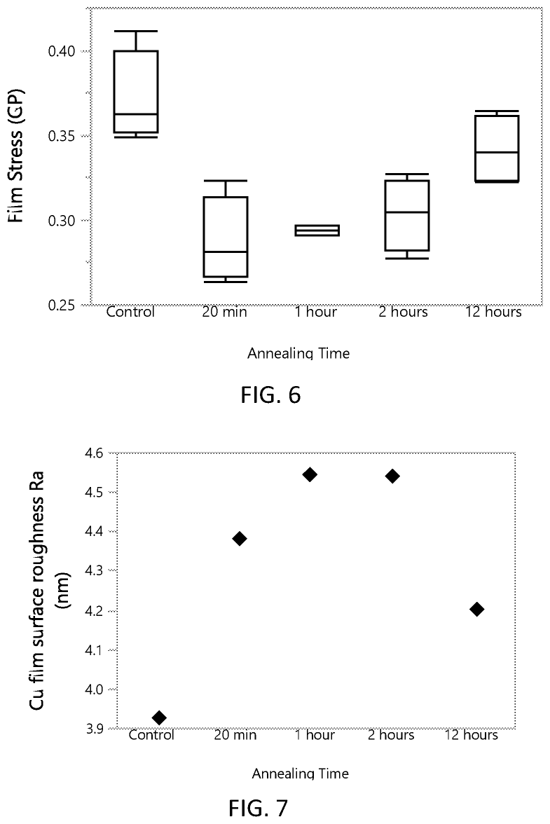

The stress of the copper film deposited on a major surface of the glass wafers was determined by observing the shape change of the glass sheet before and after copper film deposition by measuring the shape before and after copper film deposition by using a profilometer and then correlating shape change to film stress in accordance with the Stoney equation:

$${σ}_{rr}^{f} ≃ - \frac{{E}_{s} {h}_{s}^{2}}{6 ( 1 - {v}_{s} ) {h}_{f}} \frac{1}{{R}_{r}}$$

wherein, σ is the copper film stress, Eₛ is the elastic modulus of the glass substrate, vₛ is the Poisson's ratio for the glass substrate. hₛ is the glass substrate thickness, h_{f} is the copper film thickness, 1/Rᵣ is difference of reciprocal curvature radii of the substrate measured after and before deposition. FIG. 6 shows the calculated copper film stress for the control sample as well as samples heat treated for various times. As can be seen from FIG. 6, heat treatment for about 20 minutes resulted in about 23% lower calculated copper film stress than the control sample with film stress gradually increasing with increasing heat treatment time.

The surface roughness of the copper film deposited on a major surface of the glass wafers was determined by AFM. FIG. 7 shows the measured copper film surface roughness for the control sample as well as samples heat treated for various times. As can be seen from FIG. 7, heat treatment from about 1-2 hours resulted in the largest observed copper film surface roughness, which is about 15% higher than the control sample. Increasing heat treatment beyond 1-2 hours resulted in gradually decreasing copper film surface roughness.

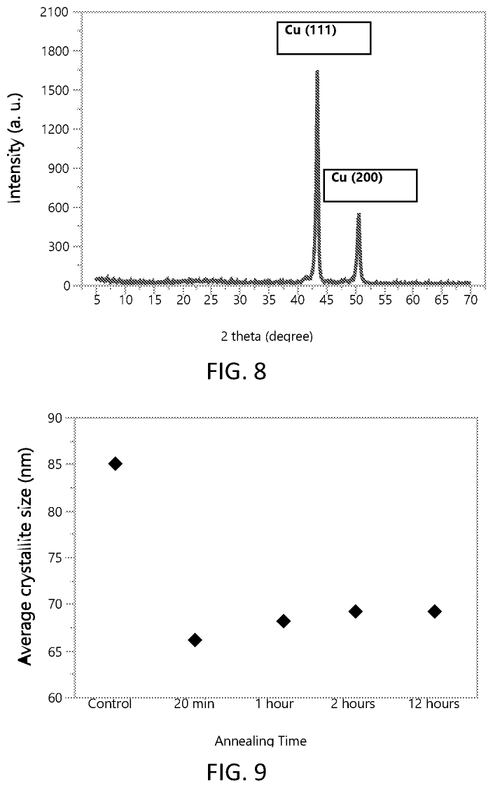

The average crystallite size of the copper film deposited on a major surface of the glass wafers was determined by grazing incidence X-ray diffraction (GIXRD). FIG. 8 shows the GIXRD curve of the copper film deposited on the control sample. As can be seen from FIG. 8, there are two main peaks (Cu (111) and Cu (200)) showing in the X-ray diffraction (XRD) curve due to copper scattering. For the control sample and each of the heat treated samples, the full width at half maximum (FWHM) of peak Cu (111) was fitted from the XRD curve, and the average crystallite size t was calculated by Scherrer Formula:

$$t = \frac{K λ}{B cos {θ}_{B}}$$

wherein K is the Scherrer constant, λ is x-ray wavelength, B is the FWHM of peak Cu (111), and θ is the peak position (2 theta). The calculated average crystallite size results are shown in FIG. 9. A can be seen from FIG. 9, the heat treated samples were determined to have a lower average crystallite size than the control sample, with the smallest average crystallite size on the sample that was heat treated for about 20 minutes. A slight increase in average crystallite size was observed for samples that were heat treated for longer periods of time.

While the above embodiments have been described with reference to a fusion down draw process, it is to be understood that such embodiments are also applicable to other glass forming processes, such as float processes, slot draw processes, up-draw processes, tube drawing processes, and press-rolling processes.

It will be apparent to those skilled in the art that various modifications and variations can be made to embodiment of the present disclosure without departing from the spirit and scope of the disclosure. Thus, it is intended that the present disclosure cover such modifications and variations provided they come within the scope of the appended claims and their equivalents.

1. A method of depositing a copper film on a major surface of a glass sheet comprising:
determining a desired range of a property of the copper film;
correlating a thermal history of the glass sheet to the desired range of the property of the copper film; and
depositing the copper film on the major surface of the glass sheet, wherein the property of the copper film deposited on the glass sheet is within the desired range.

2. The glass interleaf of claim 1, wherein the property is at least one of surface roughness, film stress, or average crystallite size of the copper film.

3. The method of claim 1, wherein correlating the thermal history of the glass sheet to the desired range of the property of the copper film comprises adjusting the thermal history of the glass sheet.

4. The method of claim 3, wherein adjusting the thermal history of the glass sheet comprises heat treating the glass sheet for a predetermined time and temperature prior to depositing the copper film on the glass sheet.

5. The method of claim 4, wherein the heat treatment time ranges from about 20 minutes to about 12 hours and the maximum heat treatment temperature ranges from about 350° C. to about 700° C.

6. The method of claim 1, wherein depositing the copper film comprises sputter deposition.

7. The method of claim 1, wherein the glass sheet has a thickness ranging from about 0.1 millimeter to about 0.5 millimeters and the copper film has a thickness ranging from about 50 nanometers to about 1000 nanometers.

8. The method of claim 4, wherein the property is film stress and the heat treatment time ranges from about 20 minutes to about 2 hours and the maximum heat treatment temperature ranges from about 350° C. to about 700° C.

9. The method of claim 4, wherein the property is surface roughness and the heat treatment time ranges from about 20 minutes to about 12 hours and the maximum heat treatment temperature ranges from about 350° C. to about 700° C.

10. The method of claim 4, wherein the property is average crystallite size and the heat treatment time ranges from about 20 minutes to about 12 hours and the maximum heat treatment temperature ranges from about 350° C. to about 700° C.

11. The method of claim 1, wherein the glass sheet comprises an alkali free glass composition comprising 58-65 wt % SiO₂, 14-20 wt % Al₂O₃, 8-12 wt % B₂O₃, 1-3 wt % MgO, 5-10 wt % CaO, and 0.5-2 wt % SrO.

12. The method of claim 1, wherein the glass sheet comprises an alkali free glass composition comprising 58-65 wt % SiO₂, 16-22 wt % Al₂O₃, 1-5 wt % B₂O₃, 1-4 wt % MgO, 2-6 wt % CaO, 1-4 wt % SrO, and 5-10 wt % BaO.

13. The method of claim 1, wherein the glass sheet comprises an alkali free glass composition comprising 57-61 wt % SiO₂, 17-21 wt % Al₂O₃, 5-8 wt % B₂O₃, 1-5 wt % MgO, 3-9 wt % CaO, 0-6 wt % SrO, and 0-7 wt % BaO.

14. The method of claim 1, wherein the glass sheet comprises a glass composition comprising 55-72 wt % SiO₂, 12-24 wt % Al₂O₃, 10-18 wt % Na₂O, 0-10 wt % B₂O₃, 0-5 wt % K₂O, 0-5 wt % MgO, and 0-5 wt % CaO, 1-5 wt % K₂O, and 1-5 wt % MgO.

15. A glass sheet comprising a major surface with a copper film deposited thereon in accordance with the method of claim 1.

16. An electronic device comprising the glass sheet and deposited copper film of claim 15.
